(19) United States
(12) Patent Application Publication
(10) Pub. No.: US 2025/0261247 A1
(43) Pub. Date: Aug. 14, 2025

(54) WIRELESS COMMUNICATION METHODS FOR RANDOM ACCESS CHANNELS, APPARATUS, AND COMPUTER-READABLE MEDIUM

(71) Applicant: ZTE Corporation, Shenzhen (CN)

(72) Inventors: Yu LIU, Shenzhen (CN); Xing LIU, Shenzhen (CN); Jing LIU, Shenzhen (CN); Junfeng ZHANG, Shenzhen (CN); He HUANG, Shenzhen (CN)

(73) Assignee: ZTE Corporation, Shenzhen, GD (CN)

(21) Appl. No.: 19/058,621

(22) Filed: Feb. 20, 2025

Related U.S. Application Data
(63) Continuation of application No. PCT/CN2022/114056, filed on Aug. 22, 2022.

(51) Int. Cl. H04W 74/0833

(52) U.S. Cl. CPC H04W 74/0833

(57) ABSTRACT

A wireless communication method includes receiving RA (Random Access) request preambles in one or more ROs (PRACH occasions) associated with a same SSB or associated with different SSBs, and transmitting corresponding one or more RA responses in response to the RA request preambles received by a BS.

### TECHNICAL FIELD

This disclosure is generally related to Random Access process, and more particularly to PRACH or Msg1 repetitions.

### BACKGROUND

Wireless communication technologies are pivotal components of the increasingly interconnecting global communication networks. Wireless communications rely on accurately allocated time and frequency resources for transmitting and receiving wireless signals.

Coverage of channel accessibility is one of the factors considered by operators for commercial use of cellular communication networks because it may have direct impacts on service quality of the wireless communications. Additionally, uplink (UL) coverage could be a bottleneck in most of scenarios in real applications, especially in high frequency cell applications. Some methods of uplink coverage enhancement may be considered, such as PUSCH (Physical Uplink Shared Channel) repetition, PUCCH (Physical Uplink Control Channel) repetition, and Msg3 (Scheduled Transmission) repetition techniques, which allow a UE to transmit UL data across multiple consecutive slots. This may improve the rate of reception success in of a base station (BS), especially when a user equipment (UE) is in the edge of cell.

### SUMMARY

This summary is a brief description of certain aspects of this disclosure. It is not intended to limit the scope of this disclosure.

An aspect of this disclosure provides a wireless communication method including: setting up at least one of the following configurations for a Random Access (RA) procedure, including:
an RA request repetition indicator, used to indicate whether a RA resource set is available for RA request repetition;
an RA request sweeping indicator, used to indicate whether a RA resource set is available for RA request sweeping;
an RA request repetition number, used to determine a number of the RA request repetition;
an RA request sweeping number, used to determine a number of the RA request sweeping;
an RSRP (Reference Signal Received Power) threshold for repetition, used to determine whether the RA request repetition is applicable for the RA procedure or used to determine which RA request repetition number should be selected among a plurality of RA request repetition numbers;
an SSB bundle (Synchronization Signal Block bundle) configuration, used to determine grouping of SSBs; or
RACH resource configuration, used to indicate a RACH resource used to transmit the RA request repetition or the RA request sweeping; and
performing the RA request repetition or the RA request sweeping according to the at least one of the configurations.

Another aspect of this disclosure provides a wireless communication method including: determining an index of start PRACH occasion (RO) by:
determining the index of the start RO=[UE_ID mod [floor (Y/X)]]×X, wherein Y is a total number of ROs associated with an SSB in an association period of SSB-to-RO mapping, X is a RA request repetition number, and UE_ID is a UE index;
determining the index of the start RO via a signaling or a pre-set rule between a UE or a BS; or
determining the index of the start RO as the first RO in an association period of SSB-to-RO mapping; and
transmitting or receiving the RA request repetition at X RO starting from the index of the start RO.

Still another aspect of this disclosure provides a wireless communication method including transmitting RA (Random Access) request preambles in one or more ROs (PRACH occasions) associated with a same SSB or associated with different SSBs; and receiving corresponding one or more RA responses in response to the RA request preambles transmitted by a UE.

Another aspect of this disclosure provides a wireless communication method including receiving RA (Random Access) request preambles in one or more ROs (PRACH occasions) associated with a same SSB or associated with different SSBs; and transmitting corresponding one or more RA responses in response to the RA request preambles received by a BS.

Still another aspect of this disclosure provides a wireless communication apparatus, including a memory storing one or more programs and a processor electrically coupled to the memory and configured to execute the one or more programs to perform any method or step or their combination in this disclosure.

Still another aspect of this disclosure provides non-transitory computer-readable storage medium, storing one or more programs, the one or more program being configured to, when executed by a processor, cause to perform any method or step or their combination in this disclosure.

The above and other aspects and their implementations are described in greater detail in the drawings, the descriptions, and the claims.

### BRIEF DESCRIPTION OF THE DRAWINGS

Various exemplary embodiments of the present disclosure are described in detail below with reference to the following drawings. The drawings are provided for purposes of illustration only and merely depict exemplary embodiments of the present disclosure to facilitate the understanding of the present disclosure. Therefore, the drawings should not be considered as limiting of the breadth, scope, or applicability of the present disclosure. It should be noted that for clarity and ease of illustration these drawings are not necessarily drawn to scale.

FIG. 1 illustrates a Contention Based Random Access procedure;

FIG. 2 illustrates a Contention Free Random Access procedure;

FIG. 3 illustrates an example PRACH repetitions with the same SSB and different SSBs;

FIG. 4 illustrates another example PRACH repetitions with the same SSB and different SSBs;

FIGS. 5-8 show example preamble partitions and parameters assignments for PRACH repetitions;

FIGS. 9-15 show example PRACH occasions bundle arrangement;

FIG. 16 shows transmission of RA preambles of legacy and updated UE in multiple ROs;

FIGS. 17-18 shows wireless communication of RA requests (Msg1) and RA responses (Msg2) and corresponding ROs and search Spaces; and

FIG. 19 shows an exemplary wireless communication system, which can implement the methods and/or steps in this disclosure.

### DETAILED DESCRIPTION

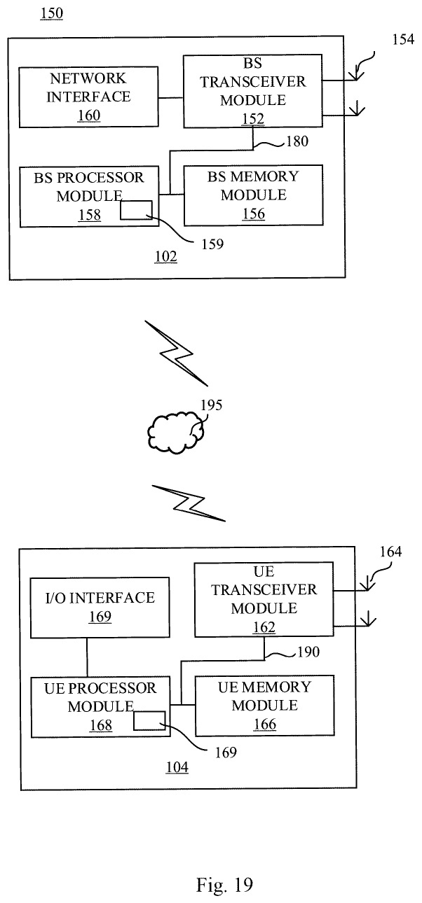

FIG. 19 illustrates a block diagram of an exemplary wireless communication system 150, in accordance with some embodiments of this disclosure. The system 150 may perform the various methods/steps disclose below. The system 150 may include components and elements configured to support operating features that need not be described in detail herein.

The system 150 may include a base station (BS) 102 and a user equipment (UE) 104. The BS 102 includes a BS transceiver or transceiver module 152, a BS antenna system 154, a BS memory or memory module 156, a BS processor or processor module 158, and a network interface 160. The components of BS 102 may be electrically coupled and in communication with one another as necessary via a data communication bus 180. Likewise, the UE 104 includes a UE transceiver or transceiver module 162, a UE antenna system 164, a UE memory or memory module 166, a UE processor or processor module 168, and an I/O interface 169. The components of the UE 104 may be electrically coupled and in communication with one another as necessary via a date communication bus 190. The BS 102 communicates with the UE 104 via a communication channel 192, which can be any wireless channel or other medium known in the art suitable for transmission of data as described herein.

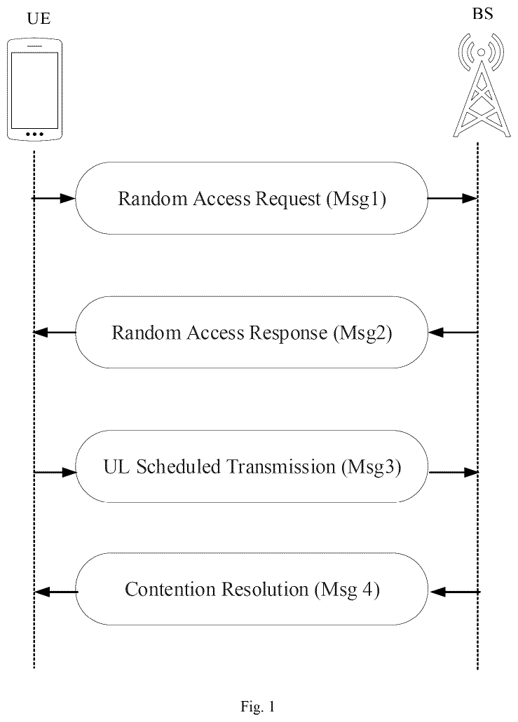

As would be understood by persons of ordinary skill in the art, the system 150 may further include any number of modules other than the modules shown in FIG. 1. Those having ordinary skill in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from a transmitting antenna of the UE 104 (referred to singular form for convenience, but can include multiple antennae) to a receiving antenna of the BS 102 (referred to singular form for convenience, but can include multiple antennae) is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a RF transmitter and receiver circuitry that are each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. There may be close synchronization timing with only a minimal guard time between changes in duplex direction. The UE transceiver 162 communicates through the UE antenna 164 with the BS 102 via the wireless communication channel 192. The BS transceiver 152 communicates through the BS antenna 154 of a BS (e.g., the first BS 102) with the other BS (e.g., the second BS 102-2) via a wireless communication channel 192. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long-Term Evolution (LTE) and 5G standards (e.g., NR), and the like. It is understood, however, that the invention is not necessarily limited in application to a particular standard and associated protocols. Rather, the UE transceiver 162 and the BS transceiver 152 may be configured to support alternative, or additional, wireless data communication protocols, including future standards or variations thereof.

The processor modules 158 and 168 may be implemented, or realized, with a general-purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)) or one or more core network 195 for mobile communications. The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

For UL (uplink) transmission, PRACH (Physical Random Access Channel) can be a main bottleneck of UL coverage. This disclosure proposes detailed PRACH repetition techniques to improve rate of successful access of the UL transmission. PRACH can be used by UEs to request an uplink allocation from the base station.

PRACH is a basic physical channel in a wireless communication system, e.g. for LTE and 5G NR. When a Random Access procedure is initiated on a Serving Cell, the UE may first select the SUL (Supplementary Uplink) or NUL (Normal Uplink) carrier(s), select a set of Random Access resources applicable to the current Random Access procedures, perform initialization of variables, and perform the Random Access (RA) Resource selection procedures.

In the RA Resource selection procedure, the UE may first select SSB(s) (Synchronization Signal Block) and one or more preambles, then may select a PRACH occasion (RO). After the RA Resource is selected, the UE may perform the RA Preamble transmission procedure.

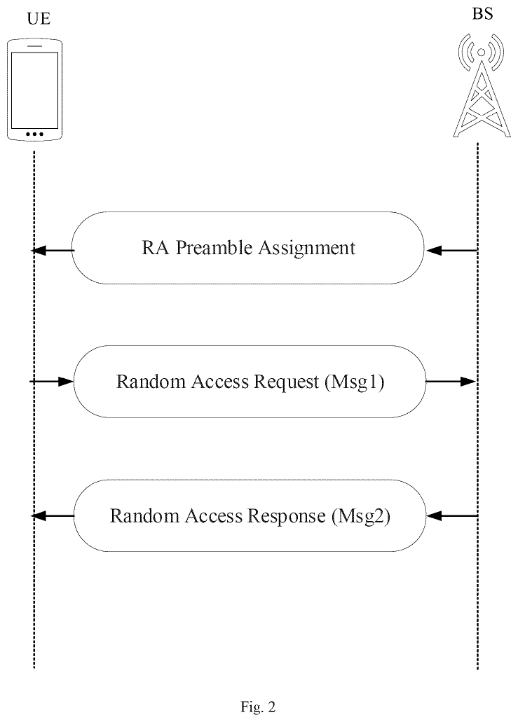

There are Contention Based Random Access (CBRA) and Non Contention or Contention Free Random Access (CFRA). According to a contention based Random access as shown in FIG. 1, a UE, among a pool of preambles shared with other UE(s), may selects a preamble randomly. CBRA is also known as four step RACH Procedure. In non-contention Random Access, preambles are allocated by a base station (BS), and such preambles are known as dedicated random access preambles. The dedicated preamble can be provided to a user equipment (UE) via different types of signaling. The steps of CFRA is illustrated in FIG. 2.

It can be beneficial if a BS (gNB) knows which beam a UE is receiving with a strongest signal. This can be achieved by connecting a specific instance of SSB (synchronization signal block) to a specific beam. The measurements can be performed on SSBs, when the UE may measure several detectable beams. Each SSB may have a parameter “time index”. With the association of an SSB time index with a specific RACH resource (such as a slot and/or preamble), the UE can use the resources when accessing the cell. The BS therefore can know which beam the UE prefers.

Additionally, beam establishment during initial access can be enabled by the possibility of associating different SSB time indices with different RACH time/frequency occasions and/or different preamble sequences. Different SSB time indices in practice may correspond to SSB transmissions in different downlink (DL) beams. The wireless communication network may be able to determine the DL beam in which the corresponding UE is located based on the received preamble. This beam can then be used as an initial beam for subsequent DL transmissions to the UE.

Additionally, if the association between SSB time index and RACH occasion is such that a given time-domain RACH occasion corresponds to one specific SSB time index, the wireless communication network may know when in the time domain the preamble transmission from UEs within a specific DL beam will be performed. The corresponding direction for beam-formed preamble reception to the UL receiver beam can be focused by the wireless communication network.

In the legacy RA procedure, the UE may only select one RO and transmits one preamble in a round RA procedure. When a failure occurs in the RA procedure, the UE may re-perform the RA Resource selection and RA Preamble transmission procedure without reselecting a set of RA resources.

To implement the novel and inventive PRACH repetition schemes, this disclosure provides the details of different aspects, including but not limited to, its configuration, its RO determination, and the RA Response Reception.

### I. Configuration

According to some embodiments of this disclosure, there can be three options for PRACH repetition.

Option 1: According option 1, PRACH repetitions can be performed with the same UL beam associated with the same SSB.

Option 2: According to option 2, PRACH repetitions can be performed with different UL beams associated with the same SSB. This option can be used for the UE that has no beam correspondence (BC) capability. For ease of description, this option can be also called “sweeping,” but this naming is not intended to limit the application of this technique.

Option 3: According to option 3, PRACH repetitions can be performed with different UL beams associated with different SSBs. Option 3 can be used to find the strongest UL beam.

For the repetitions with the same SSB (e.g., under option 1 or option 2), a “RO bundle” can be defined as consecutive or successive ROs associated with a same SSB. These ROs in the same RO bundle can be either within an association period of SSB-to-RO mapping or across a plurality of association periods. The size of a RO bundle can be determined by repetition numbers or sweeping numbers.

For the repetitions with different SSBs (e.g., repetitions according to option 3), an “SSB bundle” can be defined as an SSB set, in which a UE may transmit one or more preamble(s) in multiple ROs associated with different SSBs belonging to an SSB bundle, as long as SS-RSRP (Synchronization Signal Reference Signal Received Power) of these SSBs are above a threshold (which may be, for example, configured by the parameter rsrp-ThresholdSSB).

To accommodate the functions above and for other purpose of PRACH repetitions, a BS and or a UE can set up the at least one of the following configurations or their combinations:
(1) Msg1 (i.e., PRACH) repetition and/or sweeping indication, used to indicate whether a current RA resource set is available for Msg1 repetitions and/or sweeping;
(2) Msg1 repetition and/or sweeping numbers, used by a UE to determine the number/times of Msg1 repetitions and/or sweeping in one transmission round;
(3) RSRP (Reference Signal Received Power) threshold for repetition(s), used by a UE to determine whether a Msg1 repetition is applicable for the current Random Access procedure under the current signal condition, and/or to determine which Msg1 repetition number(s) will be selected when multiple repetition number(s) are configured;
(3) SSB bundle configuration, used by a UE to determine which SSB(s) belonging to an SSB bundle; and/or
(4) RACH resource configuration, used by a UE to transmit Msg1 repetitions and/or sweeping accordingly.

### 1. Msg1 Repetition/Sweeping Indication

For the configuration of Msg1 repetition and/or sweeping indication, the configuration can be configured explicitly or implicitly, and can be configured separately or simultaneously with other feature indication(s), such as, small data transmission, redCap (Reduced Capability) UE, Msg3 repetition configuration, and so on.

Exemplarily, it can be assumed that a UE or a RA resource set supporting Msg1 repetition can also support Msg3 repetition. In this case, when a RA resource set is indicated that Msg1 repetitions are applicable, Msg3 repetitions can also be performed in this RA resource set. Likewise, if a RA resource set is indicated that it is applicable to Msg3 repetitions, it is understood by the UE or the BS that the RA resource set is applicable to Msg1 repetition.

Exemplarily, it can be assumed that a UE or RA resource set supporting Msg1 repetitions may not necessarily support Msg3 repetitions. In this case, when a RA resource set is only indicated to be applicable to Msg1 repetitions, Msg3 repetitions is not necessarily applicable to this RA resource set. The wireless communication network may need to configure additional RA resource set indicating the Msg1 repetition applicability and Msg3 repetition applicability respectively.

Exemplarily, the BS and UE may assume that, if a Msg1 repetition number (the number of repetitions to be transmitted) is configured, whether or not the Msg1 repetition indication is configured to indicate the applicability of the RA resource sets to the Msg1 repetitions, the current RA resource set can be considered as applicable to Msg1 repetitions. Therefore, overhead for additional indication can be saved.

Exemplarily, the BS and UE may assume that if a Msg1 sweeping number (the number of repetitions to be transmitted) is configured, whether or not the Msg1 sweeping indication is configured to indicate the applicability of the RA resource sets to the Msg1 sweeping, the current RA resource set can be considered as applicable to Msg1 sweeping. Therefore, overhead for additional indication can be saved.

Exemplarily, the BS and UE can assume that, if SSB bundle configuration is configured, whether or not the Msg1 repetition indication is configured to indicate the applicability of the RA resource sets to the Msg1 repetitions, the current RA resource set can be considered as available for Msg1 repetition with different SSBs (e.g., under option 3 as described above). Therefore, overhead for additional indication can be saved.

Exemplarily, if any one of Msg1 repetition indication or a Msg1 repetition number and any one of Msg1 sweeping indication or a Msg1 sweeping number are configured simultaneously, a BS and UE can understand that the current RA resource set can be considered as available for Msg1 repetitions and Msg1 sweeping. Therefore, overhead for additional indication can be saved.

Exemplarily, if any one of Msg1 repetition indication or a Msg1 repetition number is configured with SSB bundle configuration simultaneously, the current RA resource set can be considered as available for Msg1 repetition with a same SSB (e.g., under option 1 and option 2 as described above) or different SSBs (e.g., under option 3 above). There are two examples provided as follows.

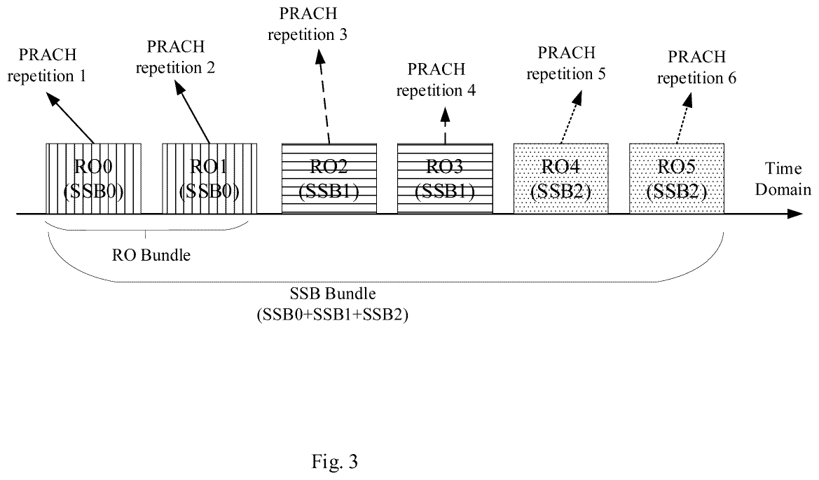

An example figure of PRACH repetition with the same SSB and different SSBs is illustrated in FIG. 3. As shown in FIG. 3, PRACH (i.e. Msg1) repetitions (including PRACH repetition 1 and PRACH repetition 2) with the same SSB (e.g., SSB0) are performed; then PRACH repetitions (PRACH repetition 3 and PRACH repetition 4) with a different SSB (SSB1) are performed. Specifically, PRACH repetition 1 and PRACH repetition 2 are of the same SSB0 and the same UL beam (as illustrated by the patterns of the arrows) associated with SSB0; PRACH repetition 3 and PRACH repetition 4 are of the same SSB1 and the same UL beam associated with SSB1; finally, PRACH repetition 5 and PRACH repetition 6 are of the same SSB2 and the same UL beam associated with SSB2. Here, RO bundles can be defined as consecutive or successive ROs associated with a same SSB. An SSB bundle can be defined as an SSB set, in which a UE may transmit one or more preamble(s) in multiple ROs associated with different SSBs belonging to an SSB bundle

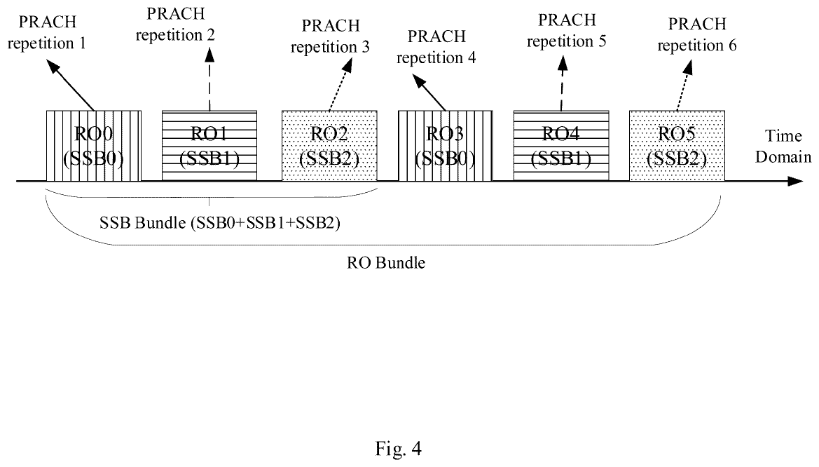

An example figure of PRACH repetition with the same SSB and different SSBs is illustrated in FIG. 4. As shown in FIG. 4, firstly PRACH repetitions with different SSBs are performed, then PRACH repetitions with the same SSB set are performed. Specifically, PRACH repetitions 1, 2, and 3 with different SSBs (SSB0, SSB1, SSB3) in an SSB bundle are performed first. Then, PRACH repetitions 4, 5, and 6 with different SSBs (SSB0, SSB1, SSB3) but in the same SSB bundle or set are performed. Here, PRACH repetition 1 and PRACH repetition 4 may have the same UL beam (as illustrated by the patterns of the arrows) associated with SSB0; PRACH repetition 2 and PRACH repetition 5 are of the same UL beam associated with SSB1; likewise, PRACH repetition 3 and PRACH repetition 6 are of the same UL beam associated with SSB2.

### 2. Msg1 Repetition/Sweeping Number

The configuration of Msg1 Repetition/Sweeping number(s) may indicate times of repetitions of the PRACH/Msg1. Msg1 repetition and/or sweeping number can be configured explicitly or implicitly. Additionally, the BS and/or UE can set up a configuration of a plurality of numbers for different network implementations and/or conditions.

Exemplarily, Msg1 repetition and/or sweeping numbers can be configured in a per-BWP (Bandwidth Part) parameter manner; the Msg1 repetition and/or sweeping number configuration is thereby shared for all feature combinations in a particular BWP.

Exemplarily, Msg1 repetition and/or sweeping numbers can be configured in a per-FeatureCombination parameter manner; in this case, the Msg1 repetition and/or sweeping numbers can be separately configured for all feature combination in this BWP.

Exemplarily, Msg1 repetition and/or sweeping numbers can be configured for RA resource set for CFRA, e.g. for SI (system information) request, CF-BFR (Contention Free-Beam Failure Recovery), reconfigurationWithSync, etc. For example, the parameter can be introduced into legacy parameter SI-SchedulingInfo, BeamFailureRecoveryConfig, rach-ConfigDedicated, etc.

Exemplarily, Msg1 repetition and/or sweeping numbers can be indicated in PDCCH (Physical Downlink Control Channel) order (i.e. DCI1_0, Downlink Control Information format 0_1). For example, the first three bits of Reserved bits in DCI1_0 may be used, wherein value “1” may indicate number value 2 may indicate number 2 and so on.

### 3. RSRP (Reference Signal Received Power) Threshold for Repetition(s)

RSRP threshold for repetitions can be assumed as a necessary configuration if RA resource set with Msg1 repetition indication and RA resource set without Msg1 repetition indication are configured in one BWP at the same time.

Additionally, if a plurality of repetition numbers are configured, a plurality of RSRP thresholds can be configured, corresponding to the plurality of repetition numbers respectively. For example, different configurations of different repetition numbers can be used when different RSPR threshold is meet. For example, when the RSRP indicates that the channel condition is weak, more times/numbers of repetitions may be transmitted to increase the rate of successful jointly decoding with multiple repetitions. The RSRP Threshold can be used to define the condition when the PRACH repetition technique must be enabled or the condition when a certain numbers/times of PRACH repetitions should be used.

Exemplarily, RSRP threshold for repetitions can be configured for RA resource set for CFRA, e.g. for SI (System Information) request, CF-BFR, reconfigurationWithSync, etc. For example, the parameter can be introduced into legacy parameters SI-SchedulingInfo, BeamFailureRecoveryConfig, rach-ConfigDedicated, etc.

### 4. SSB Bundle Configuration

Exemplarily, all transmitted SSBs can be considered as one SSB bundle. In this case, SSB bundle enabling indication may be needed in order to indicate whether the one SSB bundle is enabled.

Exemplarily, one or more SSB bundles can be configured explicitly depending on the need of a certain network implementation.

Exemplarily, SSB bundle configuration can be configured in a per-BWP parameter manner; in this case, the SSB bundle can be shared for all feature combinations in a certain BWP.

Exemplarily, SSB bundle configuration can be configured in a per-FeatureCombination parameter manner; in this case, multiple sets of SSB bundle configurations may be separately configured for all feature combination in this BWP.

### 5. RACH Resource Configuration

RACH resource configuration may indicate the RO (PRACH occasion) in time domain to be used to transmit the PRACH repetitions. For RACH resource configuration, shared RO with legacy UE and/or separate ROs can be configured. If a shared RO is used, separate preambles may be configured. There are two groups of RA-Preambles, Group A and Group B. Group A may always exist, and Group B exists only with the specific configuration in SIB 2 parameters. The determination of Group A and Group B is described in Random Access Procedure initialization standards.

Exemplarily, for a RA resource set available for Msg1 repetitions, if preambles in Group B is present, there are two methods to partition preambles as below.

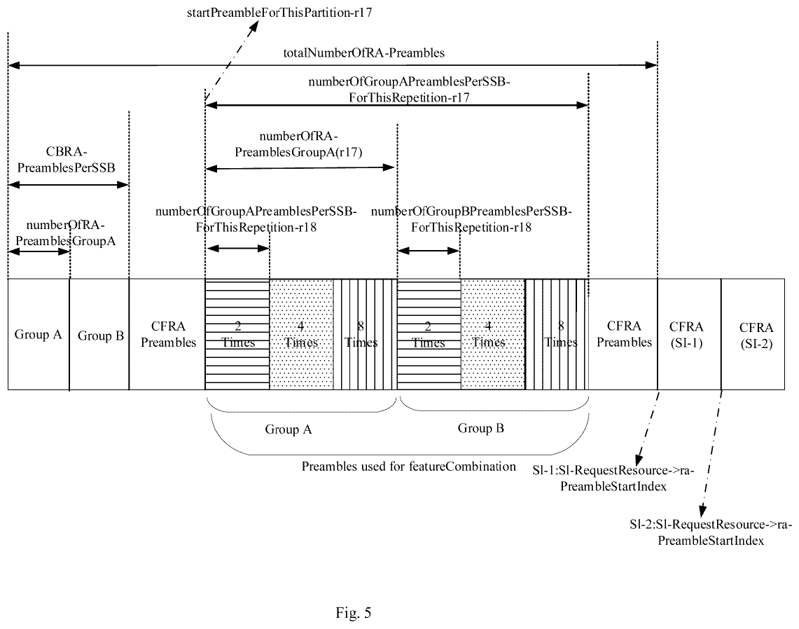

Method 1.5.1 (as shown in FIG. 5): Firstly, preambles used for PRACH repetitions are partitioned into groupA and groupB, and then each preambles group (i.e. groupA and groupB) is partitioned into a plurality of partitions; each partition is associated with a repetition number (e.g., 2 Times, 4 Times, or 8 Times, etc.).

As an example, parameter Msg1-Repetitions-r18 can be introduced into FeatureCombination-r17, which indicates that the corresponding RA resource set is applicable to PRACH repetition. Exemplarily, parameters numberOfGroupAPreamblesPerSSB-ForThisRepetition-r18 and numberOfGroupBPreamblesPerSSB-ForThisRepetition-r18 (in a case that groupB is present) for each repetition number can be introduced into BWP-UplinkCommon (i.e. under a per-BWP basis) or FeatureCombinationPreambles-r17 (i.e. under a per-FeatureCombination basis). The parameter numberOfGroupAPreamblesPerSSB-ForThisRepetition-r18 and numberOfGroupBPreamblesPerSSB-ForThisRepetition-r18 may indicate the number of preambles used for groupA and groupB of this repetition number.

Assuming there are R repetition numbers, the parameters may present for the first R−1 entries and absent for the last entry. The sum of all the numberOfGroupAPreamblesPerSSB-ForThisRepetition-r18 may usually be lower than the total num of preambles used for groupA. The sum of all the numberOfGroupBPreamblesPerSSB-ForThisRepetition-r18 may usually be lower than the total num of preambles used for groupB (if presented). For groupA preambles, the first

ΣRᵢ₌₁^{R-1} numberOfGroupAPreamblesPerSSB-ForThisRepetition-r18ᵢ

preambles can be used for the first R−1 entries successively, and the remaining preambles can be used for the last entry.

For groupB preambles (if applicable) the first

ΣRᵢ₌₁^{R-1} numberOfGroupBPreamblesPerSSB-ForThisRepetition-r18ᵢ

preambles can be used for the first R−1 entries successively, and the remaining preambles can be used for the last entry. A sample figure of preambles partition is as follows.

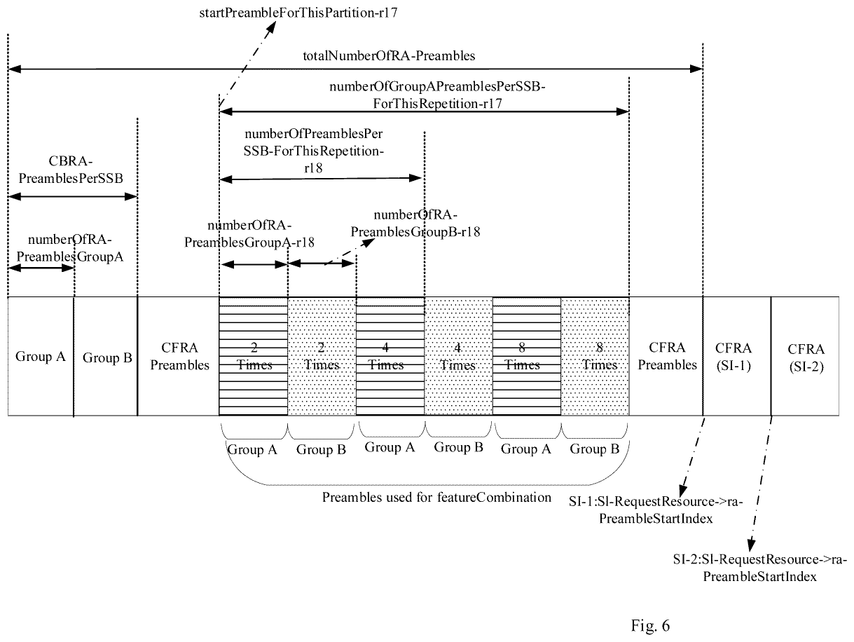

Method 1.5.2 (as shown in FIG. 6): According to this method, firstly, preambles used for PRACH repetitions can be partitioned into a plurality of partitions, and each partition can be associated with a repetition number. The partitions associated with a same repetition number are assigned into groupA or groupB. The preambles of groupA and group B may be arranged alternately.

For example, parameters numberOfPreamblesPerSSB-ForThisRepetition-r18 and numberOfRA-PreamblesGroupA (if groupB is present, used for r18) for each repetition number can be introduced into BWP-UplinkCommon (i.e. per-BWP) or FeatureCombinationPreambles-r17 (i.e. per-FeatureCombination). Additionally, parameter numberOfPreamblesPerSSB-ForThisRepetition-r18 may indicate the number of preambles used for a certain repetition number. Assuming there are R repetition numbers, the parameter numberOfPreamblesPerSSB-ForThisRepetition-r18 can be present for the first R−1 entries and absent for the remaining entr(ies). The sum of all the numberOPreamblesPerSSB-ForThisRepetition-r18 may be generally be lower than the total num of preambles used for PRACH repetitions.

For preambles of PRACH repetitions, the first

ΣRᵢ₌₁^{R-1} numberOfPreamblesPerSSB-ForThisRepetition-r18ᵢ

preambles can be used for the first R−1 entries successively, and the remaining preambles can be used for the remaining entr(ies). For each repetition, if groupB is present, the first numberOfRA-PreamblesGroupA preambles can be used for groupA, and the remaining preambles can be used for groupB.

Exemplarily, if Msg1 repetitions and Msg1 sweeping share ROs and groupB is present, two methods are disclosed below to partition preambles.

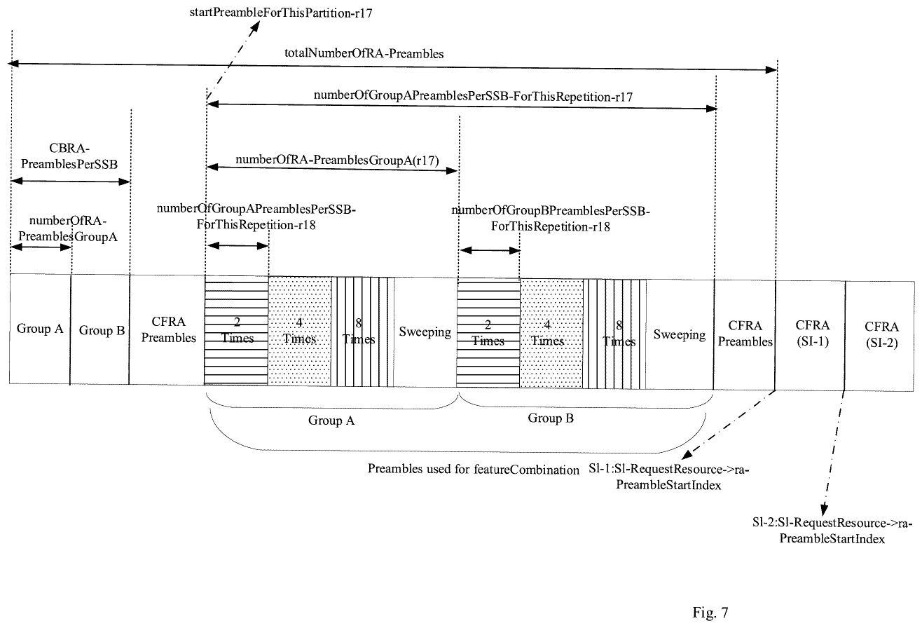

Method 1.5.3 (as shown in FIG. 7): According to this example, preambles can be partitioned into groupA and groupB, and then each preambles group (i.e. groupA and groupB) can be partitioned into multiple partitions. Each partition can be associated with a repetition number or sweeping. As shown in FIG. 7, groupA and groupB each include partitions associated with repetition numbers of 2 time, 4 times, 8 times. groupA's partitions may be consecutive with each other, and groupB's partitions may be consecutive with each other.

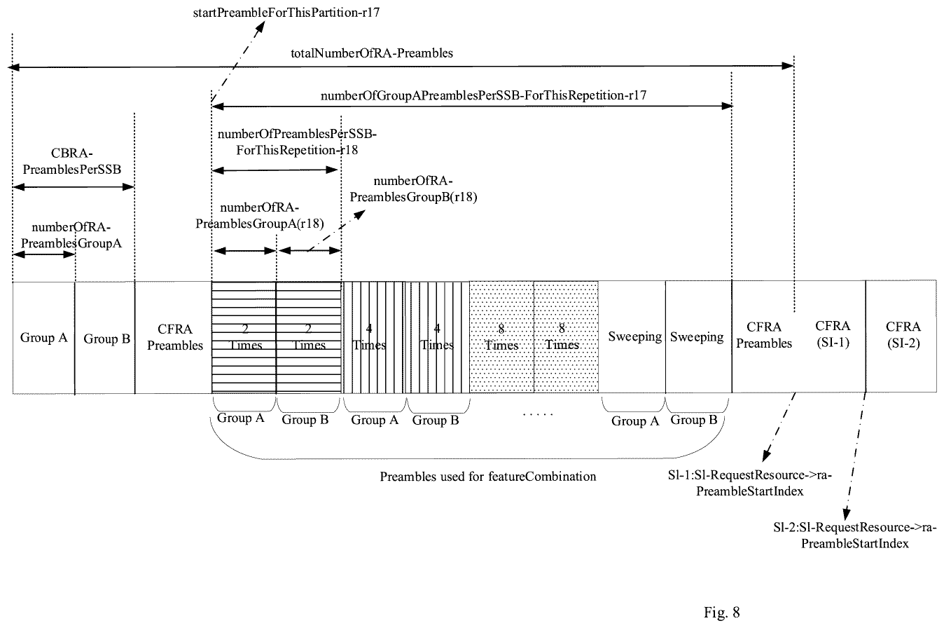

Method 1.5.4 (as shown in FIG. 8): According to this example, preambles can be partitioned into a plurality of partitions, and each partition can be associated with a repetition number or sweeping. Each partitioned preamble can be assigned to groupA or groupB. As shown in FIG. 8, partitions of groupA and partitions of groupB can be arranged alternatively.

### II. RO Determination

As disclosed above, a RO bundle can be defined as consecutive or successive ROs associated with a same SSB. These ROs in the same RO bundle can be either within an association period of SSB-to-RO mapping or across a plurality of association periods. The size of a RO bundle can be determined by repetition numbers or sweeping numbers. As disclosed below, three example approaches can be used to determine the start RO of a RO bundle.

Method 2.1: A total number of ROs associated with one SSB in an associated period of SSB-to-RO mapping is equal to Y, Y being zero or a positive integer, these ROs can be denoted as RO0, RO1, . . . , RO(Y−1); repetition (or sweeping) number can be denoted as X.

As an example:
if Y≤X (Y is equal to or less than X), the start RO of a RO bundle is RO0;
if Y>X (Y is larger than X), the start RO of a RO bundle can be determined by the following equation (1)

$$RO = \{ UE\_ID mod [ floor ( Y / X ) ] \} \times X , \qquad equation ( 1 )$$

wherein floor (Y/X) obtains a greatest integer less than or equal to Y divided by X, the mod function, denoted as mod ( ), finds the reminder of UE_ID divided by the result of the floor function, floor (Y/X). Additional examples are given as follows.

### Example 1

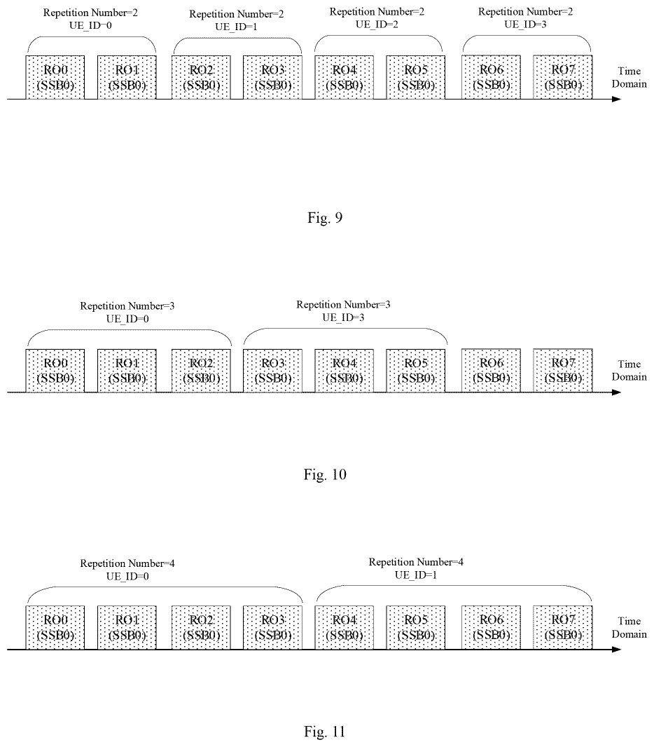

As shown in FIG. 9, in the case that Y=8 and X=2, the candidates of the start RO are {RO0, RO2, RO4, RO6}. Specifically, there are 8 ROs associated with SSB0 in the association period of SSB-to-RO mapping. When UE_ID=0, the equation (1) can be written as RO={0 mod [Floor (8/2)]}×2=0. Therefore, the start RO=0. For UE_ID=1, the start RO={1 mod [Floor (8/2)]}×2=1×2=2. Thus, the start RO is RO2. Following the same rule, the start RO for UE_ID=2 is RO4, and the start RO for UE_ID=3 is RO6. RO0 and RO1 are in a same bundle. RO2 and RO3 are in the same bundle, and so on.

### Example 2

As shown in FIG. 10, in the case that Y=8 and X=3, the candidates of the start ROs are {RO0, RO3}. The start RO for UE_ID=0 is RO0, and the start RO for UE_ID=3 is RO3.

### Example 3

As shown in FIG. 11 in the case that Y=8 and X=4, the candidates of the start ROs of the RO bundles are {RO0, RO4}. The start RO for UE_ID=0 is RO0, and the start RO for UE_ID=1 is RO4.

### Example 4

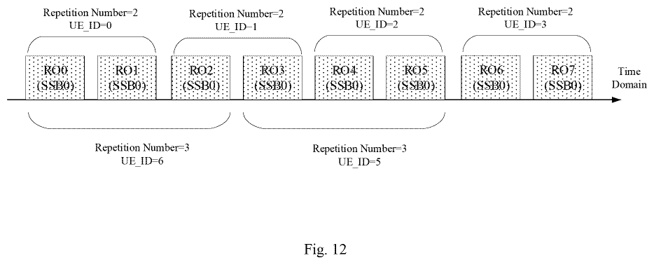

As shown in FIG. 12, in the case that Y=8 and X={2, 3}, the candidates of the start ROs of the RO bundle with X=2 are {RO0, RO2, RO4, RO6}, and the candidates of the start ROs of the RO bundle with X=3 are {RO0, RO3}. The RO bundles' mapping to the UE_ID is indicated in FIG. 12.

### Example 5

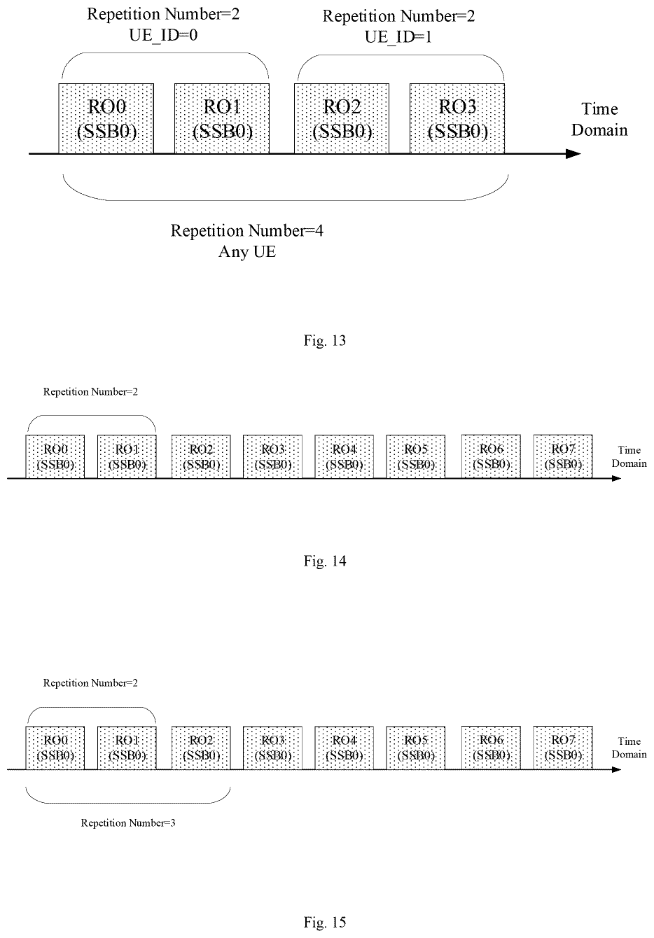

As shown in FIG. 13, in the case that Y=4 and X={2, 4}, the candidates of the start ROs of the RO bundle with X=2 are {RO0, RO2}, and the start RO of the RO bundles with X=4 is RO0. The RO bundles' mapping to the UE_ID is indicated in FIG. 12.

Method 2.2: Alternatively or additionally, the start RO of a RO bundle can configured explicitly by signalings.

Method 2.3: Alternatively or additionally, the start RO of a RO bundle can be predefined as the first RO from ROs mapped to a specific SSB.

For example, as shown in FIG. 14, in a case that Y=8 and X=2, the start RO is RO0. As another example as shown in FIG. 15, in a case that Y=8 and X={2, 3}, the start RO of both RO bundles is RO0.

### III. Random Access Response Reception

This disclosure further discloses, after a UE transmits a plurality of PRACH/Msg1 repetitions, including Msg1 sweeping and SSB bundle, how a BS can process the repetitions. Two methods as follows are exemplary methods to process the Msg1s and generate the Msg2 (Random Access Response).

### Method 3.1:

For a RO bundle, a UE may transmit preamble(s) in one or multiple ROs of the RO bundle associated with the same SSB. The network, such as the BS, may detect preambles in each RO of a RO bundle using single detection and joint detection (deciphering according to the signal from multiple ROs), and respond with Msg2(s) once preambles are detected.

According to one embodiment, at most one Msg2 is transmitted for one RO, including legacy preambles and/or feather related preambles. If a preamble is detected in multiple ROs, multiple corresponding Msg2s can be transmitted to improve the success rate of access. For each PDCCH occasion, the UE may detect Msg2(s) using multiple RA-RNTIs (Random Access-Radio Network Temporary Identifier) associated with each RO of a RO bundle.

Exemplarily, a UE may start a RAR (Random Access Response) window at the first PDCCH occasion after the first PRACH transmission. Additionally, the RAR window can be configured longer in accordance to the repetition transmission. The UE may further stop the RAR window once a Msg2 with the matched RAPID (Random Access Preamble Identifier) was received.

For a RO bundle with a size of X, assuming the ROs are denoted as RO, x=0, 1, 2, . . . , X −1, the network can successively detect RO₀, RO₁, RO₀+RO₁(joint detection), RO₂, RO₀+RO₁+RO₂, RO₃, RO₀+RO₁+RO₂+RO₃, . . . , RO_{X-1}, RO₀+RO₁+RO₂+RO₃+ . . . +RO_{X-1}, including each RO independently and any combination of RO₀ to ROₓ₋₁. The total detection numbers are 2X−1. According to one embodiment, only one Msg2 is transmitted for each RO after single detection and joint detection, including legacy preambles and/or feather related preambles, if needed. For example, for RO2, a Msg2 can be transmitted after the detection of RO₂ and RO₀+RO₁+RO₂, if needed.

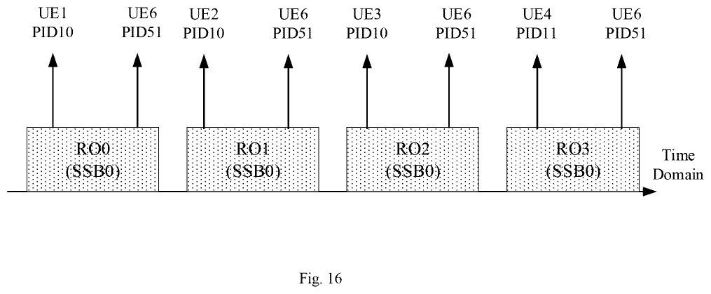

Below are the discussion regarding a system has legacy UEs and UEs supporting PRACH repetitions. In the example below, the repetition number is 4, and there are five UEs (UE1, UE2, UE3, UE4, UE6) to transmit preambles in different ROs associated with a same SSB. The UE1, UE2, UE3, UE4 are legacy UEs, and the UE6 is a new UE supporting PRACH repetitions to transmit PRACH in multiple ROs. The transmission of the preamble can be illustrated as in FIG. 16, wherein:
A preamble (PID=10) is transmitted in RO0 by UE1;
A preamble (PID=10) is transmitted in RO1 by UE2;
A preamble (PID=10) is transmitted in RO2 by UE3;
A preamble (PID=11) is transmitted in RO3 by UE4; and
A preamble (PID=51) is transmitted in RO0, RO1, RO2 and RO3 by UE6.

First, preambles may be detected in RO0, and a Msg2 as transmitted shall be scrambled by RA_RNTI_{RO}_{₀}. If only the preamble 10 (PID10 as shown in FIG. 16) was detected, a Msg2 with RAPID 10 (Random Access Preamble Identifier) is transmitted. If the preambles 10 (PID10) and 51 (PID51) were both detected, Msg2(s) with RAPIDs 10 and 51 can transmitted.

Then, preambles may be detected in RO1 independently and/or jointly in RO0+RO1. Likewise, a Msg2 shall be scrambled by RA_RNTI_{RO}_{₁}. If the preambles 10 and 51 were detected in RO1, and preambles 10 and 51 were also jointly detected in RO0+RO1, a Msg2 with RAPID 10 and 51 is transmitted. If preamble 10 was detected in RO1, and preamble 51 was jointly detected in RO0+RO1, Msg2 with RAPID 10 and 51 is transmitted. If no preamble was detected in RO1, and preambles 10 and 51 were jointly detected in RO0+RO1, Msg2 with RAPID 51 is transmitted. Here, RAPID 10 can't be included in the transmitted Msg2, since preamble 10 belongs to legacy RA resource, which can't be detected by joint detection.

Then, preambles may be detected in RO2 and jointly detected in RO0+RO1+RO2. A Msg2 shall be scrambled by RA_RNTI_{RO}_{₂}. Likewise, preambles shall be detected in RO3 and jointly detected in RO0+RO1+R02+RO3, and a corresponding Msg2 shall be scrambled by RA_RNTI_{RO}_{₁}. If any PID of a UE support PRACH repetitions is detected jointly, a corresponding Msg2 with corresponding RAPID will be transmitted by the BS. Likewise, if a PID belong to a legacy UE (not supporting PRACH repetition), a corresponding Msg2 will not be transmitted in a jointly detection event.

### Method 3.2:

Alternative or additionally, for an SSB bundle, the UE may transmit preamble(s) in one or multiple ROs associated with different SSBs belonging to the SSB bundle, as long as SS-RSRP of these SSBs are above rsrp-ThresholdSSB. The network, such as the BS, may respond with one or more Msg2s, including the UL beam priority indication if a plurality of preambles are detected in the ROs associated with SSBs of the SSB bundle. The plurality of Msg2s can be transmitted after the detection of all ROs, since the detected UL beams may need to be ranked and the priority information of UL beams is included in Msg2.

Exemplarily, the priority of the UL beam can be included in Msg2 PDU (Protocol Data Unit) or in the corresponding DCI1_0 (Downlink Control Information (DCI) format 1_0) scrambled by the RA-RNTI. For example, reserved bits in DCI1_0 scrambled by RA-RNTI can be used for UL beam priority indication.

“Search Space” or “searchspace” refers to area or areas in the downlink resource grid where PDCCH may be carried. A UE may perform decoding (e.g., blind decoding) throughout these search spaces in an attempt to find PDCCH data (e.g., DCI). Exemplarily, the SearchSpaces used for Msg2 can be associated with SSBs, since the UE may detect Msg2 in SearchSpace(s) associated with corresponding SSB(s), with which the transmitted preambles are associated respectively.

Exemplarily, if the UE transmits a plurality preambles in ROs associated with different SSBs of the SSB bundle, the UE shall detect DCI1_0 scrambled by RA-RNTI in SearchSpaces associated with these SSBs. Once the highest priority indication was received, the UE can stop to detect DCI1_0 in remaining SearchSpaces, since the strongest UL beam is found already.

Exemplarily, the UE may start the RAR window at the first PDCCH occasion after the last PRACH transmission, and the RAR window can be configured longer considering the repetition transmission. The UE may stop the RAR window once the highest priority indication was received.

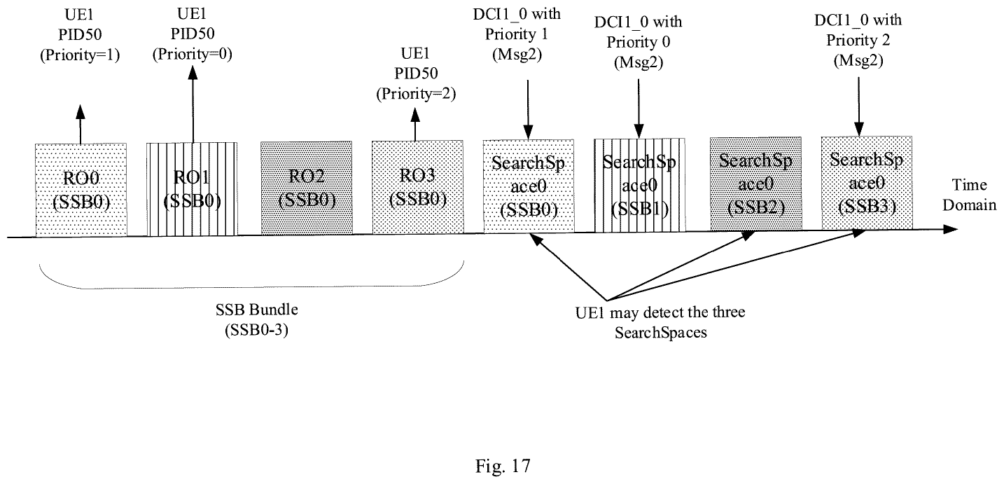

For example as shown in FIG. 17, one SSB bundle {SSB0, SSB1, SSB2, SSB3} is configured, and the preambles {50, 51} are used for PRACH repetitions. Assuming the UE transmits three preambles in RO0, RO1 and RO3 associated with SSB0, SSB1, and SSB3 of the SSB bundle, the UE may detect Msg2(s) in the corresponding SearchSpace associated with SSB0, SSB1 and SSB3. As indicated by the length of the arrows, the strongest UL beam found by the UE is the beam associated with SSB1.

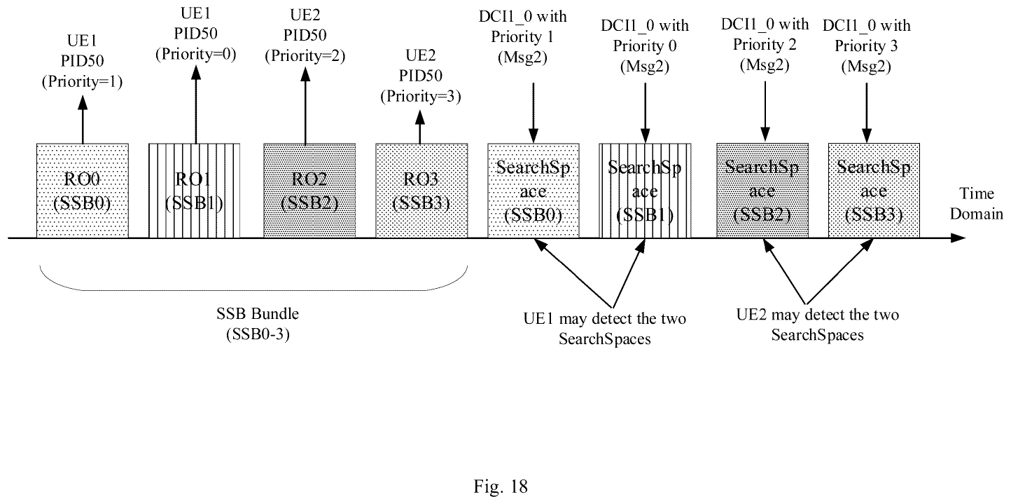

For another example as shown in FIG. 18, one SSB bundle {SSB0, SSB1, SSB2, SSB3} is configured, and the preambles {50,51} are used for PRACH repetitions. UE1 transmits PID50 in RO0 and RO1 associated with SSB0 and SSB1 of the SSB bundle, and UE2 transmits PID50 in RO2 and RO3 associated with SSB2 and SSB3 of the SSB bundle. The UE1 may detect Msg2(s) in the corresponding searchspace associated with SSB0 and SSB1, and the UE2 may detect Msg2(s) in the corresponding searchspace associated with SSB2 and SSB3. As indicated by the length of the arrows, the strongest UL beam found by the UE1 is the beam associated with SSB1, and the strongest UL beam found by the UE2 is the beam associated with SSB2.

### IV. Fallback Actions

Fallback from legacy RA procedure to Msg1 repetition procedure, or from Msg1 repetition procedure to legacy RA procedure can be allowed. For Msg1 repetition procedure, fallback from lower repetition number to higher repetition number, or from higher repetition number to lower repetition number can be allowed.

Exemplarily, these fallback procedures can be triggered by the UE initiatively, e.g. due to the change of RSRP of the downlink pathloss reference, or due to reaching the predefined number of failures, and so on.

Exemplarily, these fallback procedures can be indicated by the network, such as by the BS, e.g. through Msg2 or DCI indication.

Exemplarily, these fallback procedures can be applicable to CBRA and CFRA procedure.

The methods/steps disclosed above can be performed by the UE, the BS, and the wireless communication device as disclosed in FIG. 1. Additionally, the hardware of the UE, the BS, and the wireless communication system may include non-transitory computer readable storage medium, storing one or more instructions. When the one or more instruction is executed by a processor, a wireless communication device is caused to perform the methods/steps as disclosed above.

Various exemplary embodiments of the present disclosure are described below with reference to the accompanying figures to enable a person of ordinary skill in the art to make and use the present disclosure. The present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art would understand that the methods and techniques disclosed herein present various steps or acts in exemplary order(s), and the present disclosure is not limited to the specific order or hierarchy presented unless expressly stated otherwise.

This disclosure is intended to cover any conceivable variations, uses, combination, or adaptive changes of this disclosure following the general principles of this disclosure, and includes well-known knowledge and conventional technical means in the art and undisclosed in this application.

It is to be understood that this disclosure is not limited to the precise structures or operation described above and shown in the accompanying drawings, and various modifications and changes may be made without departing from the scope of this application. The scope of this application is subject only to the appended claims.

1. A wireless communication method, comprising:
setting up at least one of the following configurations for a Random Access (RA) procedure, including:
an RA request repetition indicator, used to indicate whether an RA resource set is available for RA request repetition;
an RA request sweeping indicator, used to indicate whether an RA resource set is available for RA request sweeping;
an RA request repetition number, used to determine a number of the RA request repetition;
an RA request sweeping number, used to determine a number of the RA request sweeping;
an RSRP (Reference Signal Received Power) threshold for repetition, used to determine whether the RA request repetition is applicable for the RA procedure or used to determine which RA request repetition number should be selected among a plurality of RA request repetition numbers;
an SSB bundle (Synchronization Signal Block bundle) configuration, used to determine grouping of SSBs; or
RACH resource configuration, used to indicate a RACH resource used to transmit the RA request repetition or the RA request sweeping; and
performing the RA request repetition or the RA request sweeping according to the at least one of the configurations.

2. The method of claim 1, wherein a RA resource set is presumed to be applicable to uplink scheduled transmission repetition of when the RA resource set is indicated by the RA request repetition indicator to be applicable to RA request repetition.

3. The method of claim 1, wherein whether M RA resource set is applicable to the RA request repetition and uplink scheduled transmission repetition is configured separately by the RA request repetition indicator and another indicator.

4. The method of claim 1, wherein a RA resource set is presumed to be applicable for the RA request repetition if the RA request repetition number and/or the RA request sweeping number is configured.

5. The method of claim 1, wherein a RA resource set is presumed to be applicable for RA request repetition or sweeping with different SSBs if a corresponding SSB bundle configuration is configured.

6. The method of claim 1, wherein n RA resource set is applicable for RA request repetition and sweeping if the RA request repetition indicator, the RA request sweeping indicator, the RA request repetition number, and/or the RA request sweeping number are so indicated or configured at the same time.

7. The method of claim 1, wherein performing the RA request repetition or the RA request sweeping according to the at least one of the configurations comprising:
transmitting RA requests in a plurality of consecutive RO bundles, wherein each of the plurality of RO bundles comprises two or more consecutive SSBs, the consecutive SSBs having a same SSB identifier; or
transmitting RA requests in a plurality of SSB bundles, wherein each of the plurality of SSB bundles comprises two or more consecutive SSBs, consecutive SSBs having different SSB identifiers.

8. The method of claim 1, wherein the RA request repetition number and/or the RA request sweeping number are shared by all feature combination in a BWP (Bandwidth Part); or
wherein the RA request repetition number and/or the RA request sweeping number are configured for the feature combinations in the BWP separately.

9. The method of claim 1, wherein the RA request repetition number and/or the RA request sweeping number are configured for RA resource set for Contention-Based Random Access or for Contention-Free Random Access.

10. The method of claim 1, wherein the RA request repetition number and/or the RA request sweeping number are indicated by a PDCCH (Physical Downlink Control Channel) order.

11. The method of claim 10, wherein the RA request repetition number and/or the RA request sweeping number are indicated by reserved bits of DCI format 1_0.

12. The method of claim 1, wherein a UE or a BS understands that the RSRP threshold is configured if a first RA resource set applicable to the RA request repetition and a second RA resource set inapplicable to the RA request repetition are configured in one BWP at the same time.

13. The method of claim 1, wherein the RSRP threshold comprises a plurality of threshold levels configured for a plurality of RA request repetition numbers, such that the different repetition numbers are applied for when different threshold levels are met.

14. The method of claim 1, wherein the RSRP threshold is configured for RA resource set for Contention-Based Random Access or for Contention-Free Random Access.

15. The method of claim 1, wherein the SSB bundle configuration indicates all transmitted SSBs in one SSB bundle and the at least one of the configurations further comprises an SSB bundle enabling indicator.

16. The method of claim 1, wherein the SSB bundle configuration is shared by all feature combination in a BWP (Bandwidth Part); or
wherein the SSB bundle configuration is configured for the feature combinations in the BWP separately.

17. The method of claim 1, wherein the RACH resource configuration indicates at least one of the following arrangements, where:
preambles used for the RA request repetition are arranged in two consecutive groups, each group including consecutive preambles associated with different Msg1 repetition numbers;
preambles used for the RA request repetition are arranged in two groups, each group including preambles associated with different RA request repetition numbers and the preambles associated with the same RA request repetition numbers in the two groups being arranged consecutively;
preambles used for the RA request repetition and sweeping are arranged in two consecutive groups, each group including consecutive preambles associated with different RA request repetition numbers or the RA request sweeping; or
preambles used for RA request repetition and sweeping are arranged in two groups, each group including preambles associated with different RA request repetition numbers or the RA request sweeping, the preambles associated with the same RA request repetition numbers in the two groups being arranged consecutively and the preambles for the sweeping in the two groups being arranged consecutively.

18. A wireless communication method, comprising:
determining an index of start PRACH occasion (RO) by:
determining the index of the start RO=[UE_ID mod [floor (Y/X)]]×X, wherein Y is a total number of ROs associated with an SSB in an association period of SSB-to-RO mapping, X is a RA request repetition number, and UE_ID is a UE index;
determining the index of the start RO via a signaling or a pre-set rule between a UE or a BS; or
determining the index of the start RO as the first RO in an association period of SSB-to-RO mapping; and
transmitting or receiving the RA request repetition at X RO starting from the index of the start RO.

19.-46. (canceled)

47. A wireless communication apparatus, comprising a memory storing one or more programs and a processor electrically coupled to the memory and configured to execute the one or more programs to:
set up at least one of the following configurations for a Random Access (RA) procedure, including:
an RA request repetition indicator, used to indicate whether an RA resource set is available for RA request repetition;
an RA request sweeping indicator, used to indicate whether an RA resource set is available for RA request sweeping;
an RA request repetition number, used to determine a number of the RA request repetition;
an RA request sweeping number, used to determine a number of the RA request sweeping;
an RSRP (Reference Signal Received Power) threshold for repetition, used to determine whether the RA request repetition is applicable for the RA procedure or used to determine which RA request repetition number should be selected among a plurality of RA request repetition numbers;
an SSB bundle (Synchronization Signal Block bundle) configuration, used to determine grouping of SSBs; or
RACH resource configuration, used to indicate a RACH resource used to transmit the RA request repetition or the RA request sweeping; and
perform the RA request repetition or the RA request sweeping according to the at least one of the configurations.

48. A non-transitory computer-readable storage medium, storing one or more programs, the one or more program being configured to, when executed by a processor, cause to perform any one of the methods of claim 1.
